(19) United States
(12) Patent Application Publication
(10) Pub. No.: US 2011/0154429 A1
(43) Pub. Date: Jun. 23, 2011

(54) INTERNAL TELEVISION ANTENNA AND METHOD FOR A PORTABLE ENTERTAINMENT MODULE

(75) Inventor: George Hristov Stantchev, Phoenix, AZ (US)

(73) Assignee: WINEGARD COMPANY, Burlington, IA (US)

(21) Appl. No.: 12/949,193

(22) Filed: Nov. 18, 2010

Related U.S. Application Data
(60) Provisional application No. 61/287,310, filed on Dec. 17, 2009.

(51) Int. Cl. H04N 7/16; H01Q 1/24

(52) U.S. Cl. 725/149; 343/702

(57) ABSTRACT

An apparatus and method using a front internal dual band television antenna or a pair of internal dual band antennas for a portable entertainment module having a housing and a display screen. A front spiral antenna is embedded in the housing around the periphery of the display screen and is tuned to compensate for the influence nearby components. A rear logo-periodic antenna is located inside the rear of the housing and is modified to have various environmental openings to fit around existing components, vents and structures in the housing. Any pair of different antenna architectures could be used.

### RELATED APPLICATIONS

This application claims the benefit of U.S. Provisional Patent Application Ser. No. 61/287,310 filed Dec. 17, 2009.

### BACKGROUND OF THE INVENTION

1. Field of the Invention

The invention relates to antennas for receiving broadcast digital television signals and, more particularly, to internal dual band television antennas for small portable entertainment modules for use in vehicles and elsewhere.

2. Discussion of the Background

A wide variety of different architectures for automotive antennas exist for a number of uses. Amplified rod antennas that mount to the exterior such as on the roof of a vehicle are used for different frequency bands such as AM and FM reception. Antennas printed on windshield glass are used for reception of AM, FM, and TV signals. Antennas exist for vehicles that receive satellite signals such as GPS, XM and Sirius signals. Cell phone antennas for vehicles use also exist. Other antennas such as fractal antennas, integrated fractal patch antennas, integrated antennas, shark-fin antennas, Bluetooth and other wireless antennas exist for a multitude of applications including for use in a vehicle.

For some time, small entertainment modules having monitors for viewing programming such as from DVDs and the like have been used internally in vehicles. Recently, these small modules are of a portable design which can be used within the vehicle or remotely there from and are small enough to be hand held. A need exists to receive broadcast television signals over the very high frequency (VHF) and ultra high frequency (UHF) bands in such small portable entertainment modules.

U.S. Pat. No. 7,084,833 B2 shows a portable television having antennas extending outwardly on either side of the screen. This antenna design increases the size of the portable television. U.S. Patent Publication No. 200710096994 provides antennas in speaker enclosures also extending from the sides of the television. Here, the two separate antennas are installed differently so their directions are 90 degrees apart. Another need exists to have the television antenna internal to the housing of the television without extensions on either side.

U.S. Patent Publication No. 2009/0153424 A1 sets forth use of an inverted L-shaped folded antenna for reception of VHF and UHF broadcast signals in a miniature receiver terminal. The antenna is placed on a separate substrate that is, for example, 100 mm by 200 mm in size. Other separate dual band television antennas are also commercially available for mounting inside portable entertainment modules including small chips such as 150 to 200 square mm in area. A further need exists to provide an internal dual band antenna for receiving broadcast television signals not confined to a small chip and that is large enough to take advantage of the size and shape of the module to improve reception.

The form factor for such small portable entertainment modules provides a set of design limitations that are critical in the concept and implementation of an internal television antenna design. The main design limitation comes from the wave length shortening due the size constraint which in most cases is greater than 20 times. A second design limitation comes from the shape used for the antenna inside the module. The shape is limited by the module design itself and the arrangement and placement of various components, air vents, and other physical structures that can be in close proximity to the antenna. A third design limitation concerns the materials used for the antenna that often requires special technologies for printing and etching. A further need exists to provide an internal antenna or a set of internal antennas within the confines of a small portable entertainment module that addresses these three design limitations and that provides maximum gain over the UHF and VHF frequency bands, especially for digital television (DTV) broadcast signals, so that the module can be used in or out of a vehicle.

### SUMMARY OF THE INVENTION

The dual band internal television antenna of the invention is designed for a portable entertainment module having a screen with a bezel around the screen and that meets the needs described above. The dual band internal television antenna has a first antenna element in the bezel that extends around and in the bezel a first length and a second antenna element in the bezel spaced from and parallel to the first antenna element that also extends a second length in the same direction as the first antenna element. The first and second signal outputs from the two elements are located at the same internal position on the bezel. The lengths of the first and second antenna elements are chosen to compensate for the reception influences caused by said portable entertainment module, materials used and components contained therein and to maximize reception of the television broadcast signals. The first antenna element is tuned to receive VHF and the second antenna element is tuned to receive UHF broadcast signals based on the antenna design, the materials used for the antenna, the shape and size of the module, and the location of various components in the module such as electronics, metal, air vents, etc.

A rear dual band internal television antenna for the portable entertainment module also meets the needs described above. The rear television antenna is a logo-periodic planar antenna printed on a substrate sized to fit in the substantial cross-section of the module and modified to be placed around environmental openings in the substrate. The modified logo-periodic planar rear antenna on the substrate is affixed inside the rear of the housing with the environmental openings accommodating components, air vents and other physical structures.

The method of the invention receives VHF/UHF digital broadcast television signals in a portable entertainment module with a dual band front internal antenna embedded in the module around a display screen. The rear dual band internal antenna may also be used in the rear of the housing. The rear antenna has elements modified in shape to have environmental openings to fit around components, vents and the like inside the housing. The signal output from the front and rear internal antennas are combined together.

The summary set forth above does not limit the teachings of the invention especially as to variations and other embodiments of the invention as more fully set out in the following description taken in connection with the accompanying drawings.

### BRIEF DESCRIPTION OF THE DRAWINGS

FIG. 1 illustrates the docking of the small portable entertainment module receiving broadcast digital VHF/UHF television signals to the head rest posts of a vehicle.

FIG. 2 is a planar view of the front of the module of FIG. 1 illustrating the placement of the front antenna of the invention.

FIG. 3 is a partial exploded perspective view of FIG. 2 showing the front antenna embedded in the bezel of the module around a touch screen.

FIG. 4 is a front planar view of the front antenna of the invention.

FIG. 5 is a side planar view of the front antenna of the invention.

FIG. 6 is a perspective view of the front antenna of the invention.

FIG. 7 is a partial cutaway view showing the mounting of the front antenna into the bezel.

FIG. 8 is an antenna configuration diagram for the front antenna.

FIG. 9 sets forth the antenna gain of the front antenna.

FIG. 10 is a planar view of the rear antenna.

FIG. 11a sets forth the details of the rear antenna as printed on a substrate.

FIG. 11b is a table showing the dimensions for the rear antenna of FIG. 11a.

FIG. 12 is an exploded perspective view showing the rear antenna mounted to a printed circuit board.

FIG. 13 sets forth the antenna gain of the rear antenna.

FIG. 14 is a perspective view showing the rear antenna mounted in the rear of the module.

FIG. 15 is an enlargement of an area of FIG. 14 showing the connection of the rear antenna inside the module.

FIG. 16a sets forth the connection circuitry combining the received signals from the pair of antennas.

FIG. 16b sets forth the connection circuitry using a switch to select the received signals from the front or rear antenna.

FIG. 17 is a cross section of the small portable entertainment module through section line 17-17 of FIG. 1.

FIG. 18 sets forth the method of the invention.

FIG. 19a is a performance plot of the front antenna.

FIG. 19b is a performance plot of the rear antenna.

FIG. 19c is a performance plot of the combined front and rear antennas.

### DETAILED DESCRIPTION OF THE INVENTION

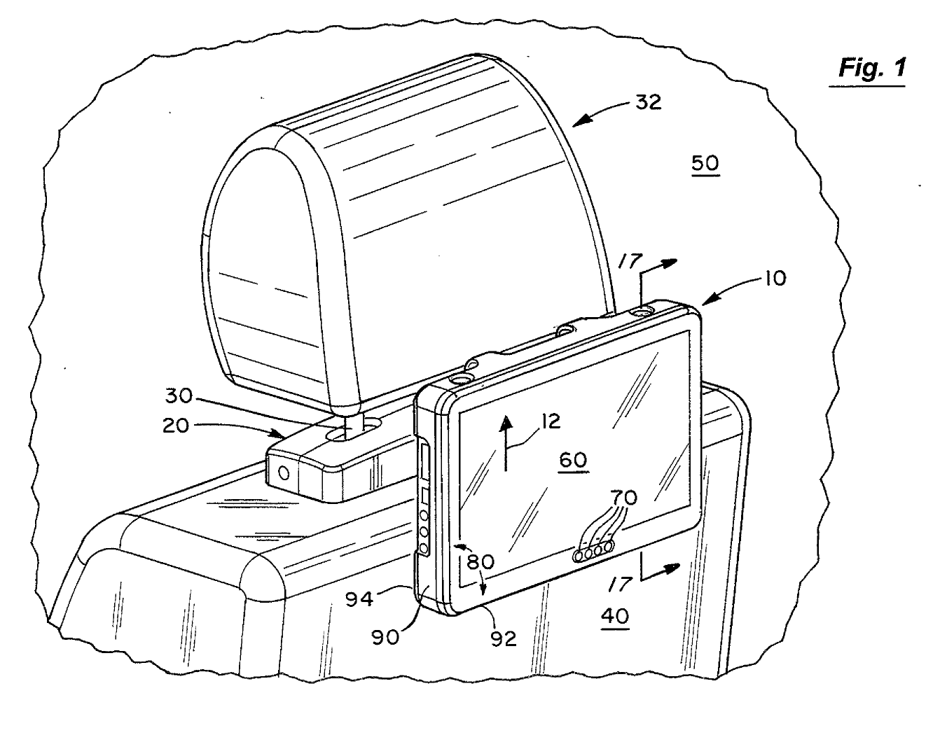

FIG. 1 shows a small portable entertainment module 10 docked to a head rest mount 20 connected to the posts 30 of a head rest 32 of a seat 40 within a vehicle 50. The portable entertainment module 10 can be removed in any suitable fashion from the mount 20 such as by moving the module 10 in the direction of arrow 12. The module 10 can then be hand carried for use in or out of the vehicle 50 such as outdoors or docked on any suitable mount or docking station located elsewhere. FIG. 1 is showing one embodiment of the portable entertainment module of the present invention, other embodiments are not limited to being connected to head rest posts. Indeed, the module 10 can be a hand held module for use in a residence, outside, etc.

While the module 10 has a number of entertainment uses (such as playing games, DVDs, etc.), one use is to receive broadcast digital television signals. The present invention provides one built-in antenna, in one embodiment, or a pair of built-in antennas of different architectures, in another embodiment to receive such broadcast digital television signals.

The module 10 has a touch screen 60, controls 70 and a surrounding bezel 80 as part of the housing 90. The bezel 80 acts as a rim around the touch screen 60 at the front 92 of housing 90. As will be discussed later in more detail, the bezel 80 contains an embedded front antenna generally located around the screen 60 and hidden from view. The use of the front antenna (i.e., an internal dual band television antenna) in the bezel 80 is one embodiment of the invention. While the term “bezel” is used herein, it is to be understood that any rim (or other peripheral structure) around the screen display of a module 10 could contain the front antenna. The term “screen” includes not only a touch screen, but any suitable display such as a conventional TV screen, video monitor, etc.

The housing 90 optionally contains a rear antenna (i.e., an internal dual band television antenna) located within the rear 94 inside of the housing 90. The use of the rear antenna in the rear 94 in combination with the front antenna is a second embodiment of the invention.

Each of the two internal dual band antennas is designed to accommodate the physical dimensions and shape of the housing 90 and to provide maximum gain over the very high frequency (VHF) and ultra high frequency (UHF) frequency bands. Both antennas implement specific and different architectures to achieve the best VHF/UHF reception of electromagnetic waves with different polarization over the two wide frequency bands. Preferably, a high gain dual spiral antenna is implemented in the bezel 80 of the housing 90 as the front antenna and a modified logo-periodic planar antenna is implemented inside the rear 94 of the housing 90 as the rear antenna. In one embodiment only the high gain dual polarization spiral front antenna is used. In another embodiment both front and rear antennas as a set are used.

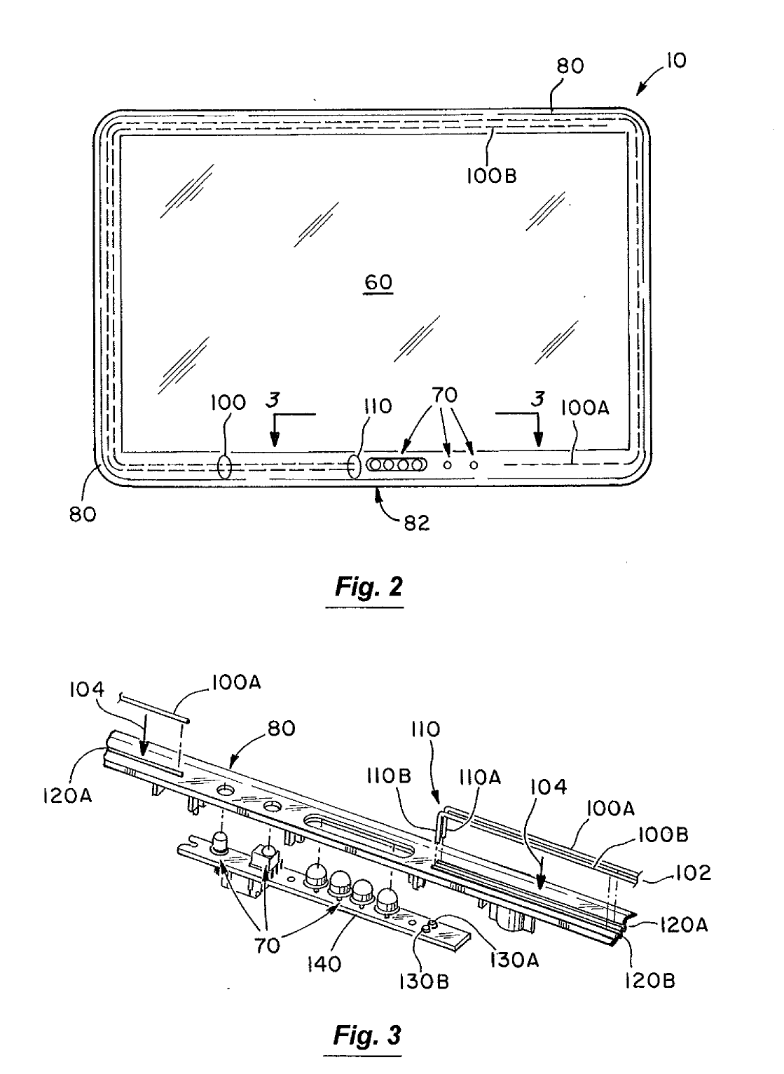

In FIGS. 2 through 8, the front internal dual band antenna 100 is shown for one embodiment. The front antenna 100 is a high gain dual polarization modified spiral antenna having two elements: a longer element 100A and a shorter element 100B. The front antenna 100 has a signal output 110 with two outputs 110A and 110B. Both elements 100A, 1008 are directed in the same direction around the bezel 80 which as shown in FIG. 2 is in the clockwise direction (as the user looks at screen 60) from the signal outputs 110 near the bottom center 82 of bezel 80, in this embodiment. The term “near” also includes “at” the bottom center 82. Other embodiments could place the signal outputs elsewhere along the bezel 80.

Each element 100A and 100B is preferably a wire made of conductive material. The conductive material is preferably copper, aluminum, or brass and the wire is preferably about one millimeter in diameter. The spacing 102 between elements 100A and 1008 is small such as preferably about two millimeters. In other variations, conductive material could be deposited on a surface of the bezel or other surface rather than using wires. Wires, however, are more rigid and easier to work with.

As shown in FIG. 3, the wire elements 100A and 1008 are press-fit into one millimeter wide and one millimeter deep grooves 120A and 1208 formed in the bezel 80. The wire elements 100A and 1008 are moved in direction 104 into the grooves 120A and 120B. The outputs 110A and 110B pass through formed holes (not shown) in the bezel 80 to engage two output connectors 130A and 1308 located on a printed circuit board 140. Each output 110A and 110B press-fits into each output connector 130A and 1308 respectively.

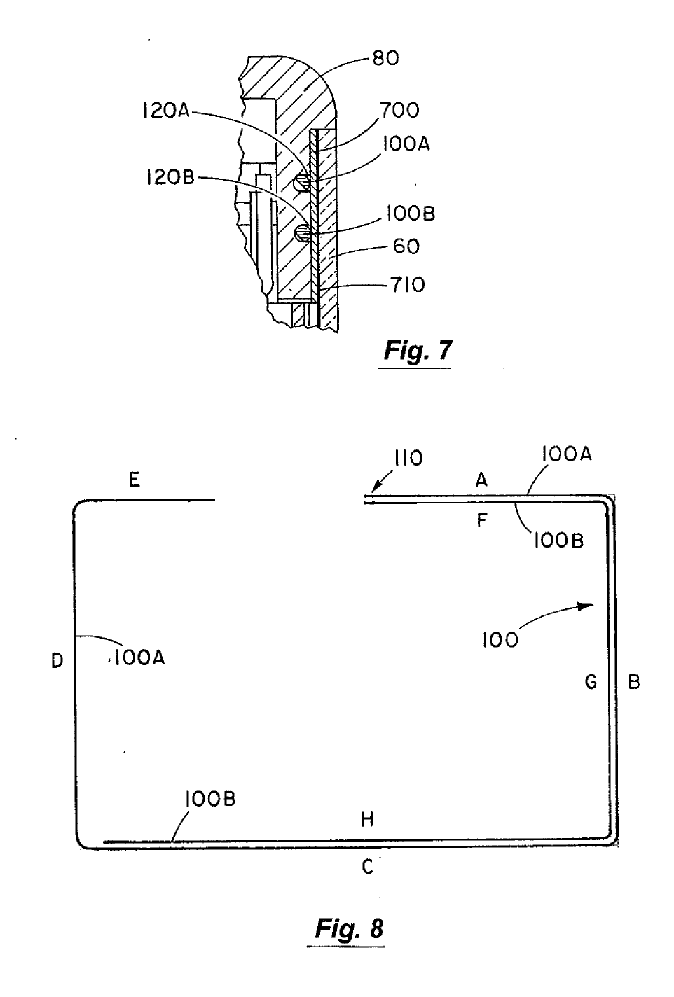

FIG. 7 shows the elements 100A and 1008 press-fitted into grooves 120A and 120B of bezel 80. When assembled, a layer of adhesive 700 is applied over the elements 100A and 100B to hold the edge of touch screen 60 to the bezel 80. A silk-screen layer 710 (shown below the touch screen) such as black hides the front antenna 100 from view.

The front antenna 100 fits into the small module 10 (approximately 262×171 mm), within the bezel 80, around the periphery of the screen 60. This provides a small aperture that is about 20× shorter than the wave lengths for receiving VHF/UHF signals. As an example, the lower VHF wave length is about 6 m and the higher wave length is about 1.2 m, i.e. the shortening wave coefficient is about 25 times considering the largest antenna dimension at the lower antenna band. The UHF lower side wave length is 0.666 m and the higher end 0.353 m which is about 1.4 times wave shortening factor in the higher end of the antenna operation frequency band. The front antenna 100 must also topologically fit into the size and shape of the bezel 80 of the housing 90 without interfering with use of the touch screen 60 by a user.

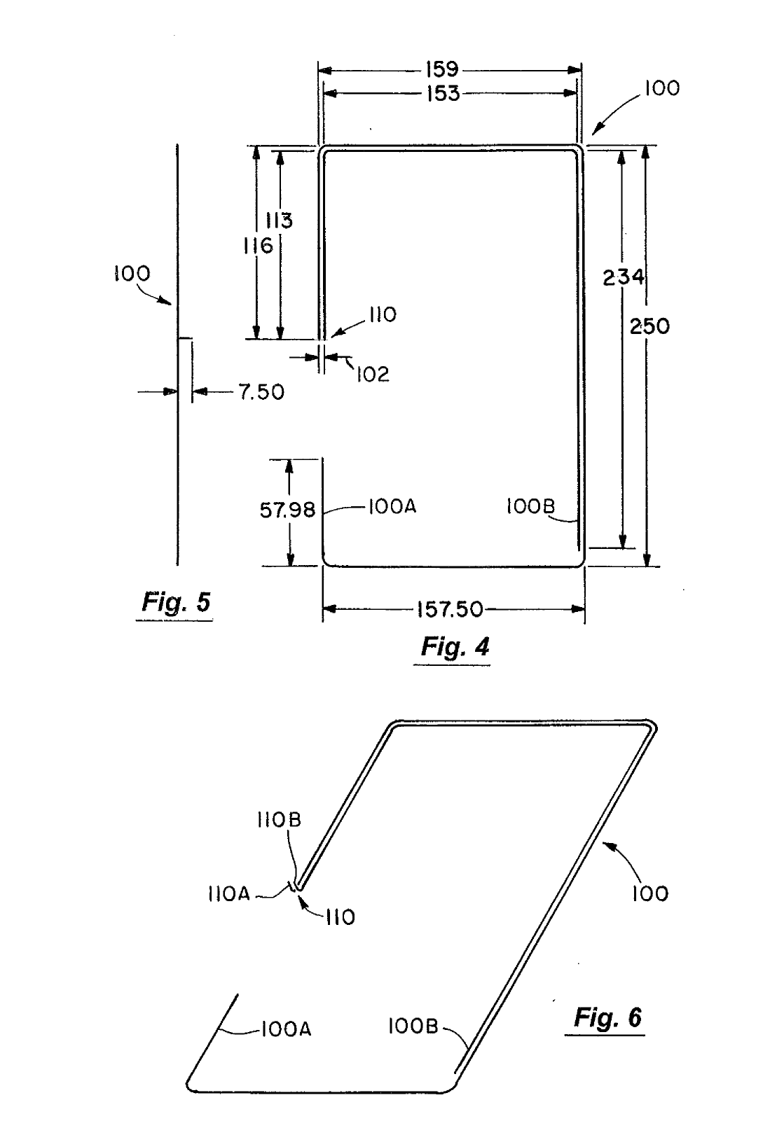

The front antenna 100 uses two elements 100A and 100B as shown in the embodiment of FIGS. 4, 6, and 8. In FIG. 5, the longer element 100A has a length of 740.48 mm and the shorter element 1008 has a length of 502.71 mm. The length of the elements is calculated as a quarter wave length for the middle of the VHF band to be 500 mm (element 100A) and for the middle of the UHF band to be 115 mm (element 100B). Although this is true for free space straight elements, the embedded antenna dimensions have to be adjusted during antenna tuning with the appropriate frequency band compensations. The length of the elements has to be adjusted to compensate for the additional shortening caused by the influence of the surrounding components in module 10. The closely located metal and PCB components within the housing 90 usually act as tuned circuits for selected frequency bands that deviate the antenna performance at those bands. Additionally these components increase the reactive capacitive impedance component of the front antenna 100 which is equivalent to additional shortening of the length that needs to be compensated. As an example, there is an embodiment of the front antenna 100 with 666 mm and 266 mm lengths for elements 100A and 100B and an embodiment with 509 mm and 113 mm lengths for elements 100A and 1008 for different component arrangements.

For a better understanding of the front antenna 100 configurations and tuning, FIG. 8 shows every arm labeled with letters A to H. One optional configuration for a free space antenna would be ABC (element 100A) plus F (element 100B) as stated above. The enclosure 90 and electronic components influence the antenna and drive additional limitations that need to be compensated. The embedded front antenna 100 can work in ABCDE (element 100A) plus FGH (element 1008) configuration or ABCD (element 100A) plus FGH (element 1008) configuration as well in ABCD (element 100A) plus FG (element 100B) configuration to provide best gain and to overcome large metal objects influence (as for example the large LCD 60 in the middle of the bezel 80 that acts as a tuned circuit for certain frequency bands). In a preferred mode while installed around the LCD display the front antenna of this invention operates with configuration ABCD plus FGH. Again, depending on the design of the module 10 and components therein, the actual configuration and lengths of elements 100A and 1008, embedded around the screen, would change in order to “tune” for best overall antenna performance. The end of an element may be adjusted to extend into a side partially (as shown by element 110A for side E) or substantially (as shown by element 1008 for side H) to obtain such “tuning.”

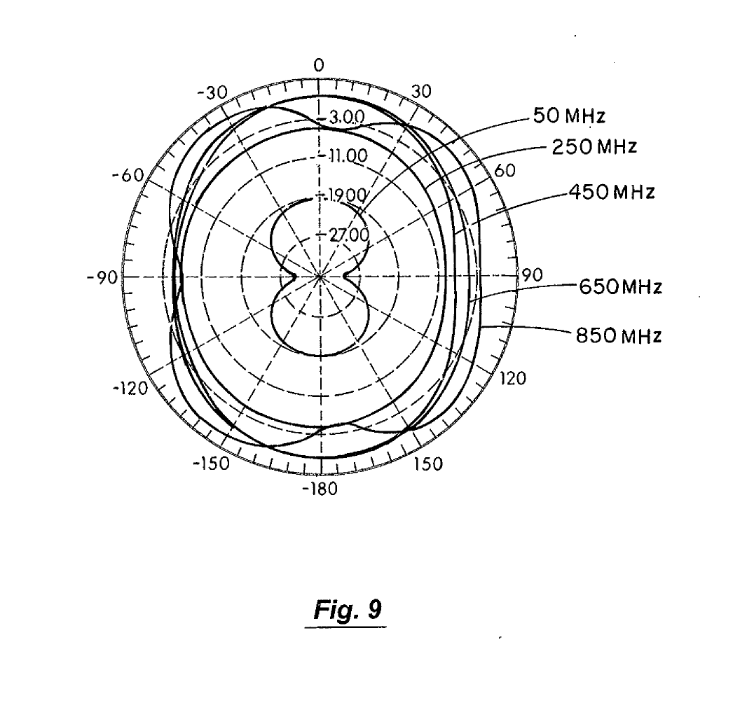

All other dimensions in millimeters are shown for the front antenna embodiment in FIGS. 4 and 5. Based on these dimensions and antenna shape an antenna gain chart is shown in FIG. 9 for the five frequencies shown. The impedance of the antenna is related to its length, thickness of the elements 100 and the distance 102 in between them. The element distance limitation 102 is driven from the bezel configuration, that limitation also affects the element thickness. Based on the element length, antenna configuration and materials used, the antenna is tuned to around 200 ohms of impedance that advises a 4:1 matching configuration.

The high gain dual polarization internal front antenna 100 is implemented around and behind the front LCD glass 60 in the bezel 80 at the front of the module 10. The design is a modified dual-arm spiral antenna topology and is positioned in the bezel 80 behind the front glass 60 to provide high gain and wideband polarization independent frequency performance. The change of polarization is an issue in mobile environments and can be noted often in the portable module 10 use due either to improper or limited holding positions. The DTV transmission is horizontally polarized in its majority of occurrences. The spiral antenna arms 100 are located along the X and Y coordinates to cover the change of the polarization. Therefore the front antenna 100 is designed to provide maximum gain due the critical dimension change in times to the wavelength while receiving signal with inconsistent polarization. The way the polarization independence works is because the antenna 100 has an active region where the antenna feed is attached and that region corresponds to the rotation of the pattern along the arms 100A, 1008 of front antenna 100. The received pattern corresponds to the direction of the spiral arms and exhibits a peak on the horizontal and vertical axis. Typically the pattern is broad and the gain slightly more than that of a dipole.

In summary, the front internal dual band antenna 100 architecture of this embodiment comprises a first spiral antenna element 100A having a first length that extends in one embodiment around the bezel 80 from a first signal output 110A and a second spiral antenna element 100B parallel to, but spaced from, the first spiral antenna element 100A that extends around and embedded within the bezel 80 from a second signal output 110B in the same direction as the first spiral antenna element 100A. The first and second signal outputs 110A, 1108 are at the same position on the bezel 80 near the bottom center 82; however, any suitable position around the bezel 80 could be used. The first element 110A is longer than the second element 110B and the elements 110A, 1108 have lengths that are tuned to provide optimum VHF/UHF antenna performance based on the size and shape of the module 10, materials used for the antenna 100 and the reception influences caused by said portable entertainment module such as: the housing 90, the screen 60, and any nearby metal and electronic components.

A method of receiving television broadcast signals is also set forth above and in summary includes the steps of: receiving television broadcast signals in a first antenna element 110a, embedded in the housing 90 around the display screen 60, having a length tuned (1) to receive very high frequency broadcast television signals and (2) to compensate for reception influences caused by said portable entertainment module; receiving the television broadcast signals in a second antenna element 110b, embedded in the housing around the display screen and parallel to the first antenna element 110a, having a length tuned (1) to receive ultra high frequency broadcast television signals and (2) to compensate for reception influences caused by said portable entertainment module; and combining signal outputs from the first and second antenna elements 110a and 110b.

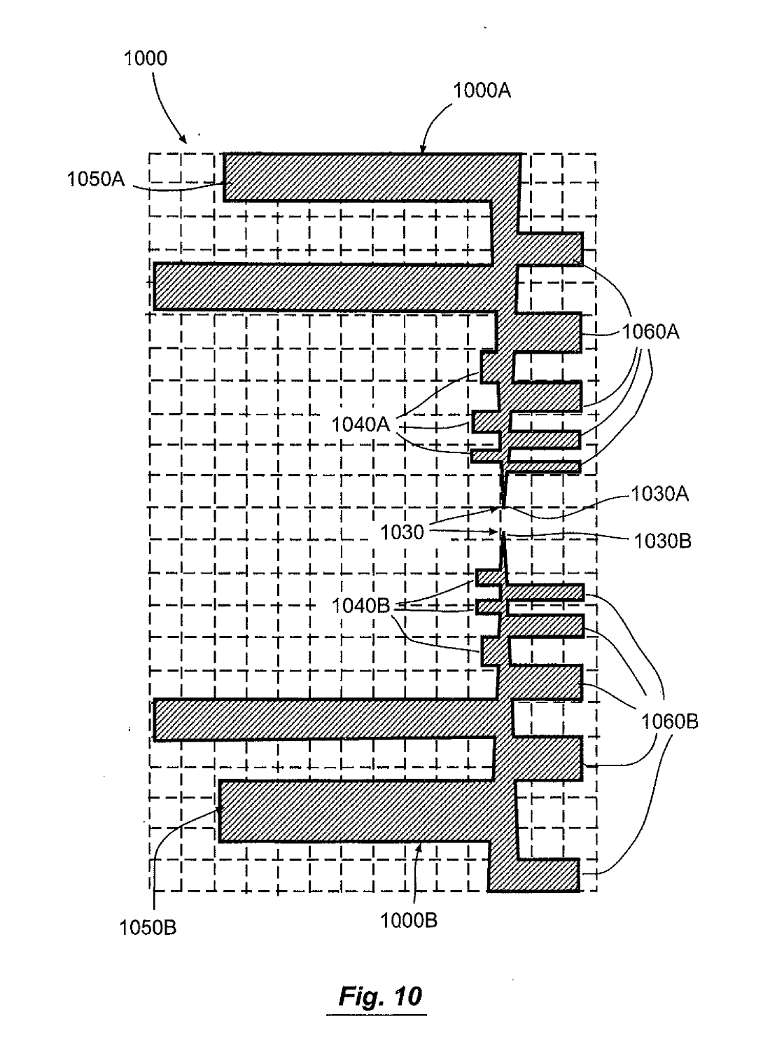

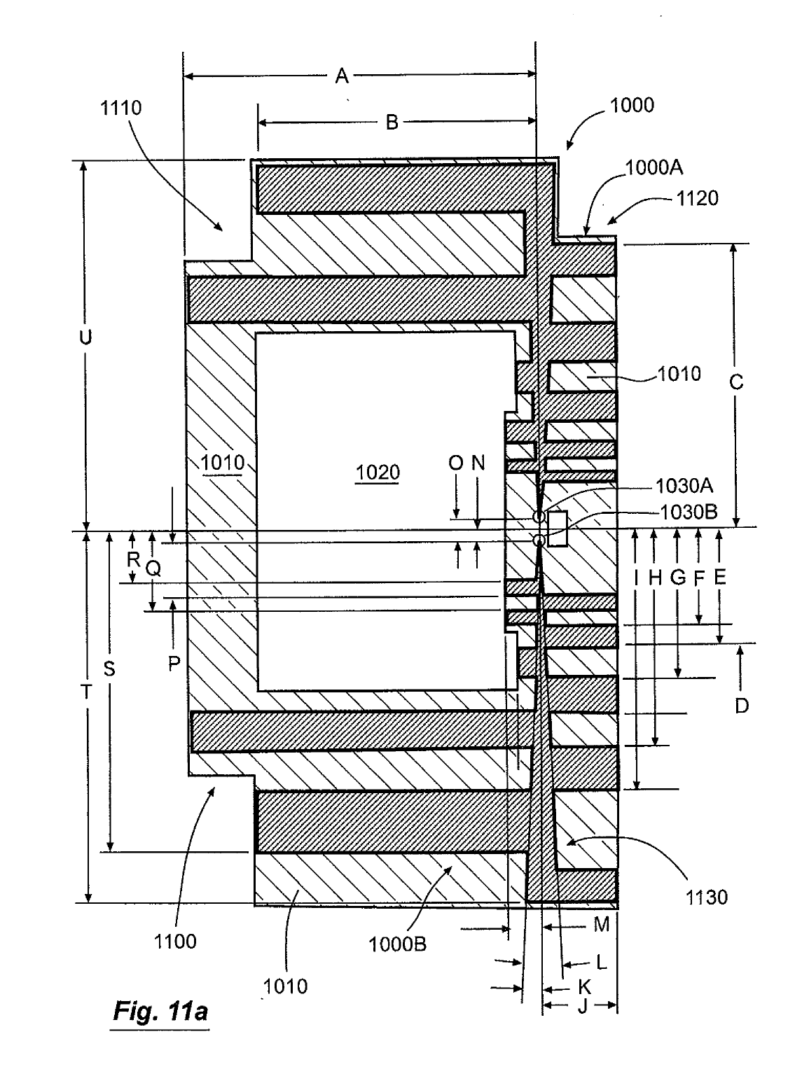

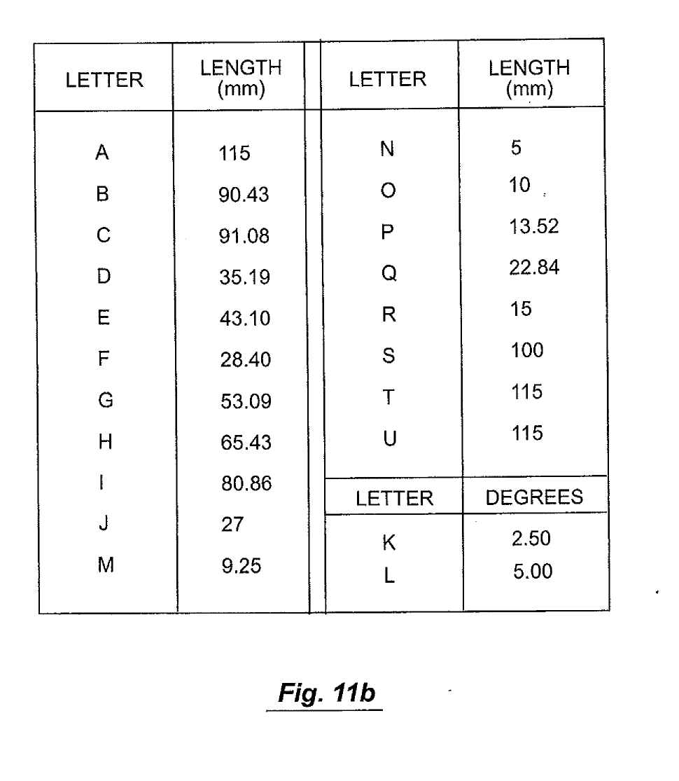

In FIG. 1, the rear portion 94 of the module 10 contains the rear antenna 1000 which is detailed in FIGS. 10, 11a and 11b for one embodiment. FIG. 10 shows antenna 1000 on a graph background. The rear antenna 1000 is preferably uses a logo-periodic antenna topology modified to fit inside module 10 and around existing venting, components and circuitry within module 10. The rear antenna 1000 is printed on a substrate 1010, such as translucent MYLAR, having about 0.10 mm thickness. As well the antenna may be constricted from tin or metal sheet for improved performance. The printed antenna 1000 is about 0.1 mm thick and printed with copper or aluminum ink. The logo-periodic planar rear antenna 1000 provides wideband operation in the VHF/UHF bands. FIG. 11b sets forth all dimensions for this embodiment of the rear antenna 1000 in millimeters. The rear internal dual band antenna 1000 has two dipole arms 1000A and 1000B forming a signal output 1030 with two dipole outputs 1030A and 10308.

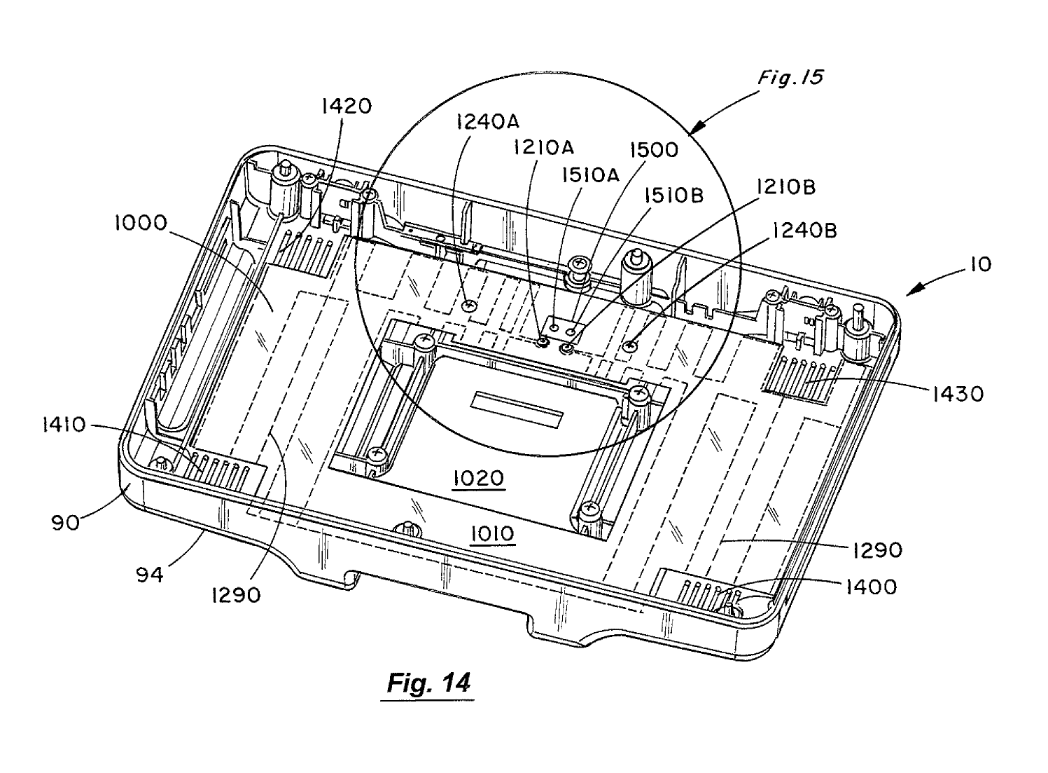

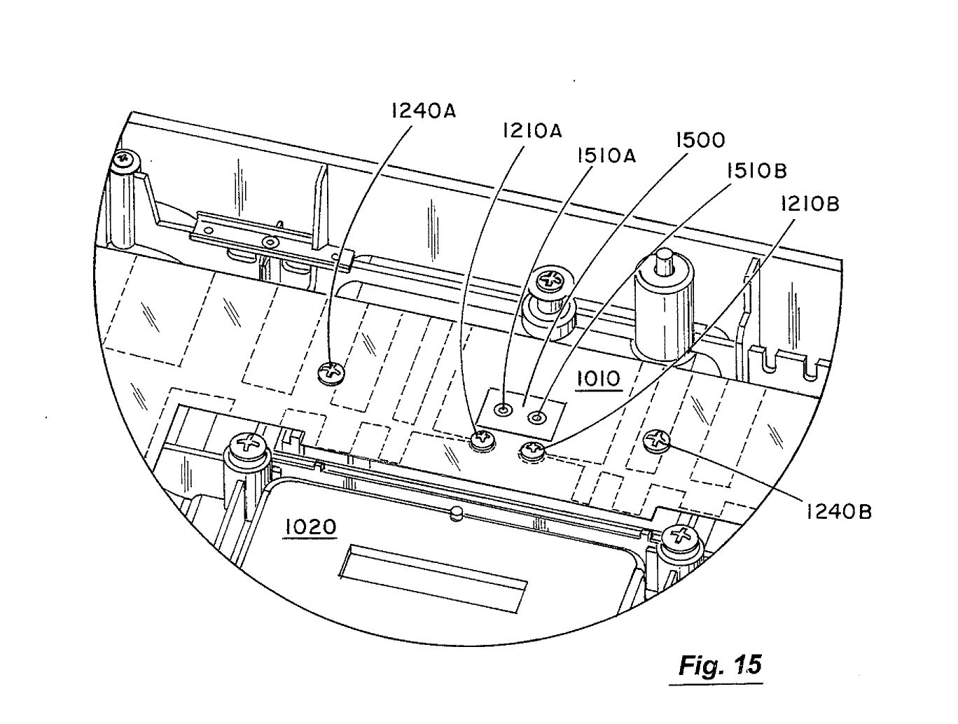

The MYLAR substrate 1010 has a large central formed environmental opening 1020. The signal output 1030 is shifted towards one side because of the environmental opening 1020. The log periodic rear antenna 1000 is modified to have environmental openings such as opening 1020 to fit around venting, components and other circuitry within the module 10. Elements 1040A and 1040B are substantially shortened to adapt to the requirements of environmental opening 1020 in substrate 1010. Likewise, elements 1050A and 1050B are somewhat shortened to accommodate air vents within the module 10. All elements 1060A and 1060B are substantially shortened to fit near an inside wall of the module 10 as explained in more detail with respect to FIGS. 14 and 15.

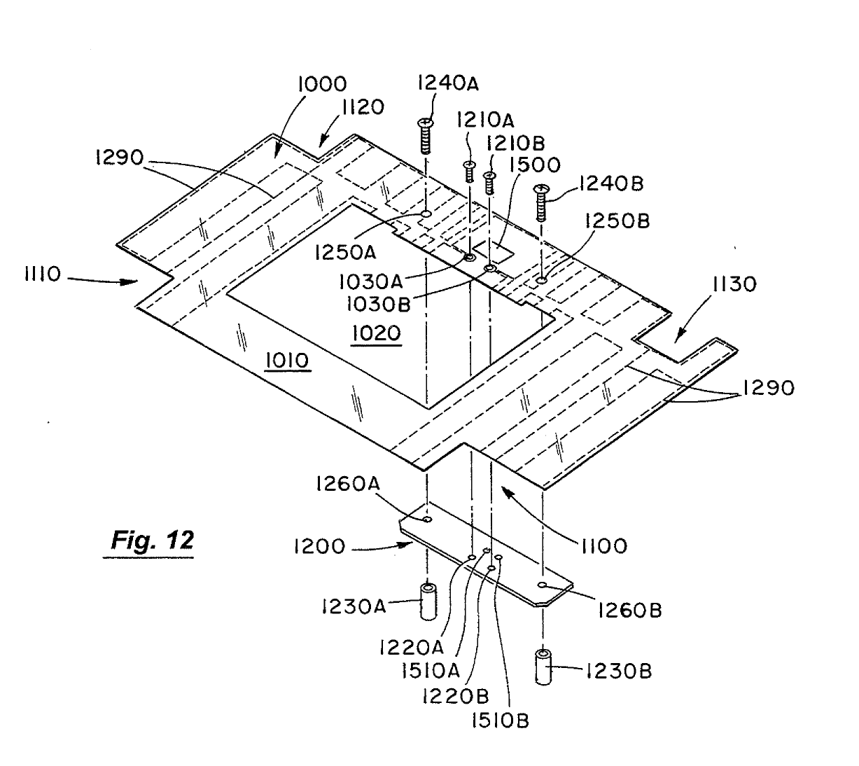

FIG. 12 shows how the signal outputs 1030A and 10308 of the rear antenna 1000 on substrate 1010 mount to a printed circuit board 1200. Screws 1210A and 1210B connect the signal outputs 1030A and 1030B through formed holes 1220A and 1220B. Screws 1240A and 1240B connect posts 1230A and 1230B to the board 1200 through holes 1250A, 1260A and 1250B, 1260B, respectively.

Printed circuit board 1200 contains conventional circuitry (not shown) which processes the VHF/UHF signals from outputs 1030A and 1030B and which provides the processed signal outputs at 1510A and 15108. The signal output connectors 1510A, 1510B are fitted into the formed window 1500 of the MYLAR sheet 1010.

In FIGS. 14 and 15, the rear antenna 1000 is shown mounted inside module 10 at the rear 94 to occupy substantially the entire rear cross-sectional area of the housing 90. The screws 1240A and 1240B engage the posts 1230A and 1230B which in turn are conventionally affixed to the inside of housing 90. The rear antenna 1000 is further secured within the housing 90 by 25 mm wide adhesive strips 1290 that are shown at FIGS. 12 and 14 on opposing edges of the Mylar sheet 1010.

At the four corners of the antenna 1000 are more formed environmental openings 1100, 1110, 1120, and 1130 that further modify the shape of the rear antenna 1000 as discussed above for FIG. 12. As shown in FIG. 14 these environmental openings in substrate 1010 are over air vents 1400, 1410, 1420 and 1430, respectively, to provide air cooling paths inside the module 10. The rear antenna 1000 is further modified to provide an environmental opening 1020 which configures around existing components of the module 10. The term “environmental openings” is defined to mean openings in the substrate 1010 that allow the substrate 1010 to fit around components or other structure inside the housing and/or vents for air circulation.

The geometry of the logo-periodic rear antenna 1000 is chosen for its electrical properties that repeat periodically with the logarithm of the frequency. The logo-periodic antenna design approach is also known as a frequency independent approach. A properly designed logo-periodic antenna pattern provides wide frequency reception. The rear antenna 1000 is connected to the feed via PCB assembly and a balun transformer (not shown) for impedance normalization.

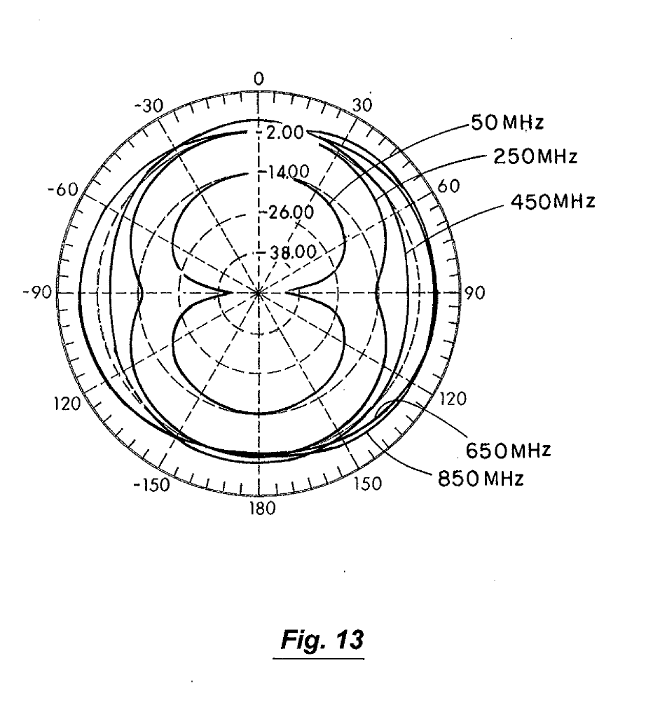

The rear antenna gain chart for the above embodiment is shown in FIG. 13 for five in-band frequencies.

In summary, the rear antenna 1000 architecture of this embodiment is a logo-periodic antenna printed on a substrate that is modified to fit inside the housing 90 with environmental openings over rear vents and over other components and structures. The modified logo-periodic antenna 1000 is affixed inside the rear 94 of said housing 90 with the environmental openings over vents and other components. In its best mode the invention uses the rear antenna 1000 in combination with the front antenna 100 to compensate the gain loss from the influence of large metal body components in or on the module 10.

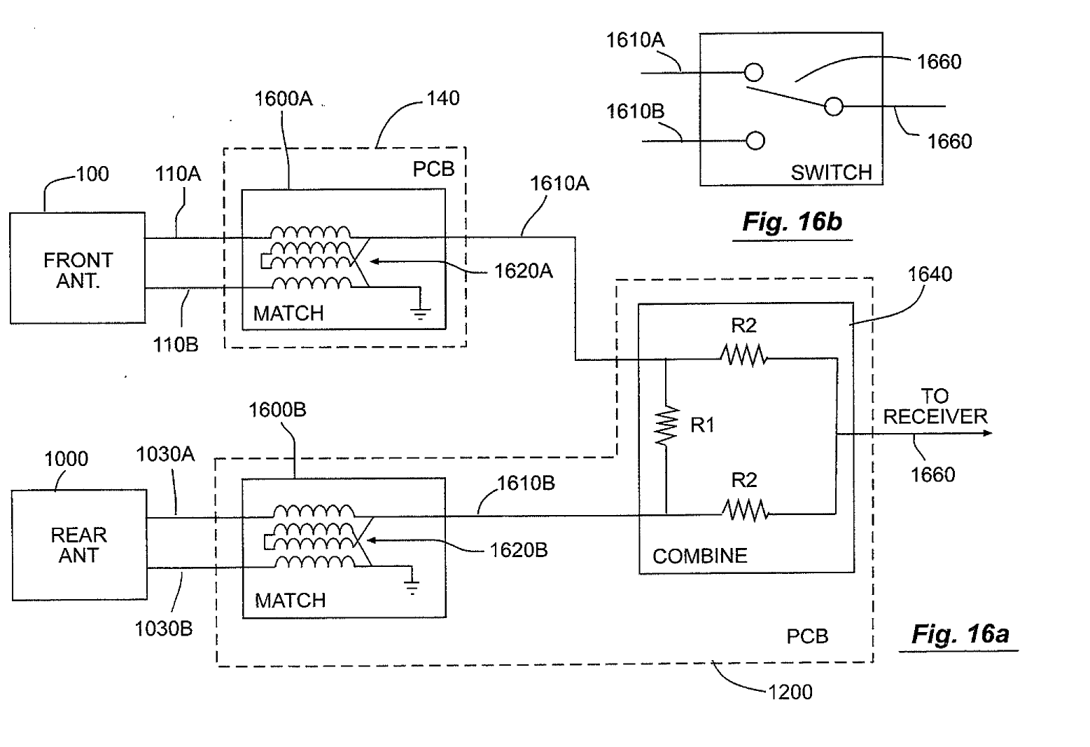

One embodiment of connection circuitry for operatively connecting the signal outputs of each antenna 100, 1000 together is shown in FIG. 16a. It is to be understood that other conventional connection circuitry could be used.

The outputs 110A, 1108 of the front antenna 100 are connected to an impedance matching circuit 1600A located on printed circuit board (PCB) 140. The circuit 1600A has a 4:1 Balun transformer 1620A for matching the 200 ohm balanced impedance on outputs 110A, 110B to a 50 ohm unbalanced output 1610A.

The outputs 1030A, 1030B of the rear antenna 1000 are connected to an impedance matching circuit 1600B located on printed circuit board 1200. The circuit 1600B also has a 4:1 Balun transformer 1620B for matching the 200 ohm balanced impedance on outputs 1030A, 1030B to a 50 ohm unbalanced output 1610B.

The television output signal from match circuit 1600A is delivered from output 1610A and the television output signal from match circuit 16006 is delivered from output 1610B to conventional combining circuit 1640, in one of its embodiments, having resistors R1 (100 ohms) and R2 (70.5 ohms). The combining circuit 1640 combines the 50 ohm signals from the antennas 100, 1000 together for delivery of a combined television signal over output 1660 to the digital television receiver (not shown) within the module 10. In addition that circuit may include compensation components for any phase and impedance misalignments of the received signal from the two antennas. In another embodiment the combining circuit 1200 may implement an antenna decision directed diversity circuitry. In another embodiment as shown in FIG. 16b, a switch 1650, such as a single pole dual throw (SPDT), is used to select one of the outputs 1610A or 1610B for delivery of the television signal.

A number of different circuits can be used to connect the two antennas together and/or to provide impedance matching for each individual antenna. The signal 1660 from the antennas 100 and 1000 is fed to a dual band TV tuner front-end via conventional VHF and UHF filters (all not shown). The filters are designed to reject all out of band signals with better than 40 dB and have better than 1.5 dB very low in band ripple and insertion loss.

The dual DTV front end incorporates two LNAs for the VHF (40-245 MHz) band and UHF (470-862 MHz) band. Each LNA has 4 gain modes, which are 18 dB, 7 dB, −3 dB and −21 dB typically. The signals are then fed to an AGC amplifier (not shown) with 36 dB gain controlled with 0.5 dB step. All of this is of conventional design and can vary based on design requirements.

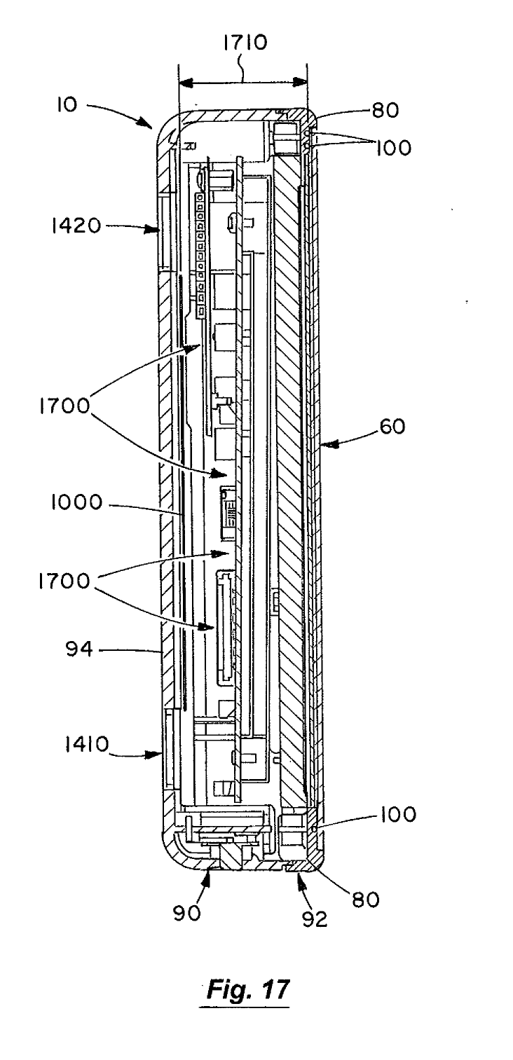

A pair of VHF/UHF internal antennas 100, 1000 exhibiting different architectures for a portable entertainment module having a housing and a display screen has been presented above. As shown in FIG. 17, the pair of VHF/UHF antennas 100, 1000 comprise a spiral antenna 100 embedded in the bezel 80 around the periphery of the display screen 60 in the housing and a second logo-periodic antenna 1000 located inside the housing at the rear. The logo-periodic antenna 1000 is modified to have environmental openings so as not to block air vents 1410, 1420 or interfere with existing components, generally referred to as 1700. In FIG. 17, the spacing 1710 between the two antennas is about 28 mm.

What has been described above is the provision of two internal dual band antennas, in one embodiment of the invention, wherein each internal antenna is of a different antenna architecture: a spiral front antenna 100 and a logo-periodic rear antenna 1000. It is to be understood, that other antenna architectures could be utilized to provide the pair of antennas. For example, the architecture for the rear antenna could include a frame, loop, fractal, dipole, etc. antenna modified to fit within the inside rear of the module 10. Likewise, the front antenna could include any suitable architecture that does not interfere with use of the screen 60. The VHF/UHF output signals from the pair of different antennas 100, 1000 are combined together for use.

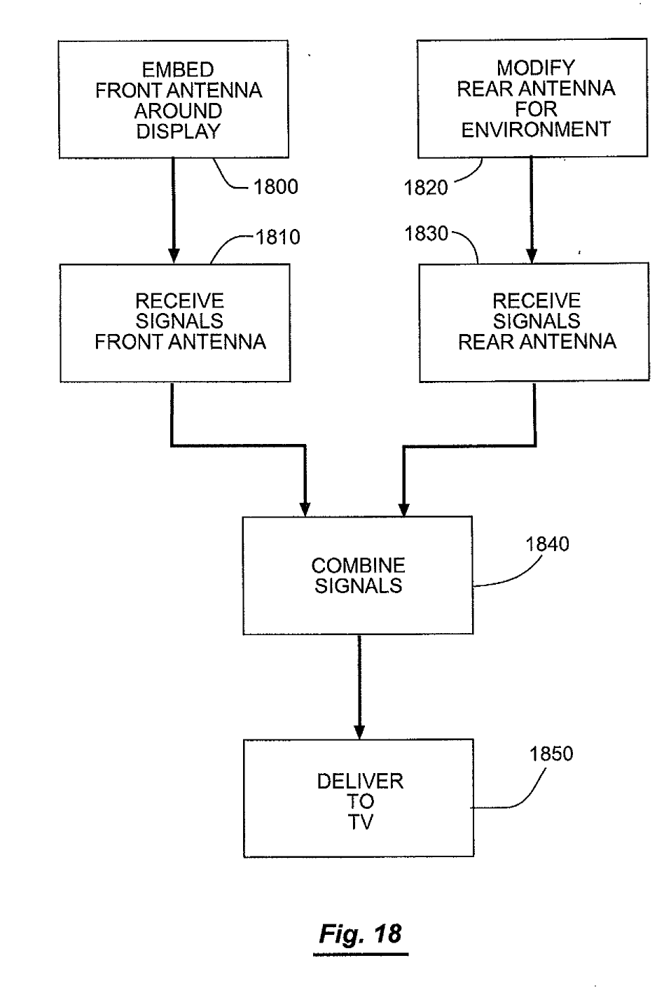

The method of using a pair of antennas is shown in FIG. 18. A front internal antenna 100 of a first architectural type (e.g., spiral) is embedded around the display screen of a portable entertainment module and tuned to compensate for the influence of nearby components and structure in step 1800. The front internal antenna 100 receives broadcast digital UHF/VHF television signals in step 1810. A rear internal antenna 1000 of a second architectural type (e.g., logo-periodic) is modified to have environmental openings fit around components, vents, and other structures inside at the rear of the module in step 1820. The rear internal antenna 1000 receives broadcast digital UHF/VHF television signals in step 1830. The signals in steps 1810 and 1830 are combined in step 1840 for delivery to the television in step 1850.

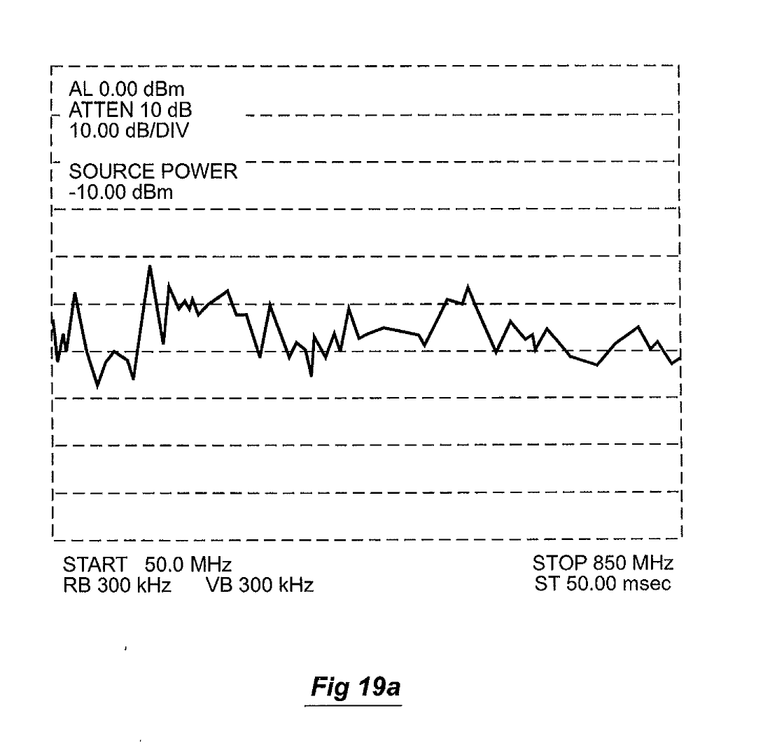

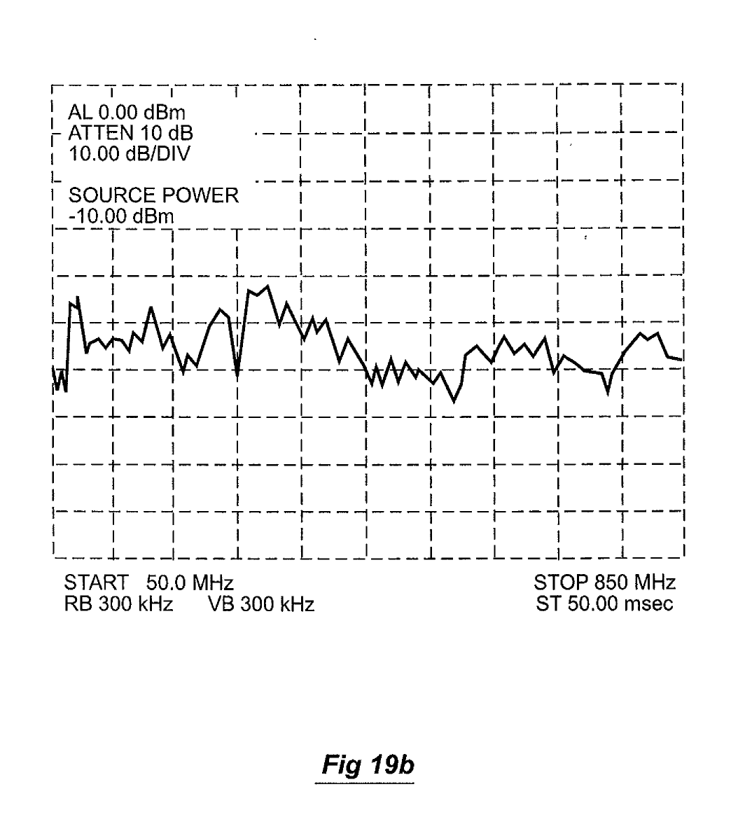

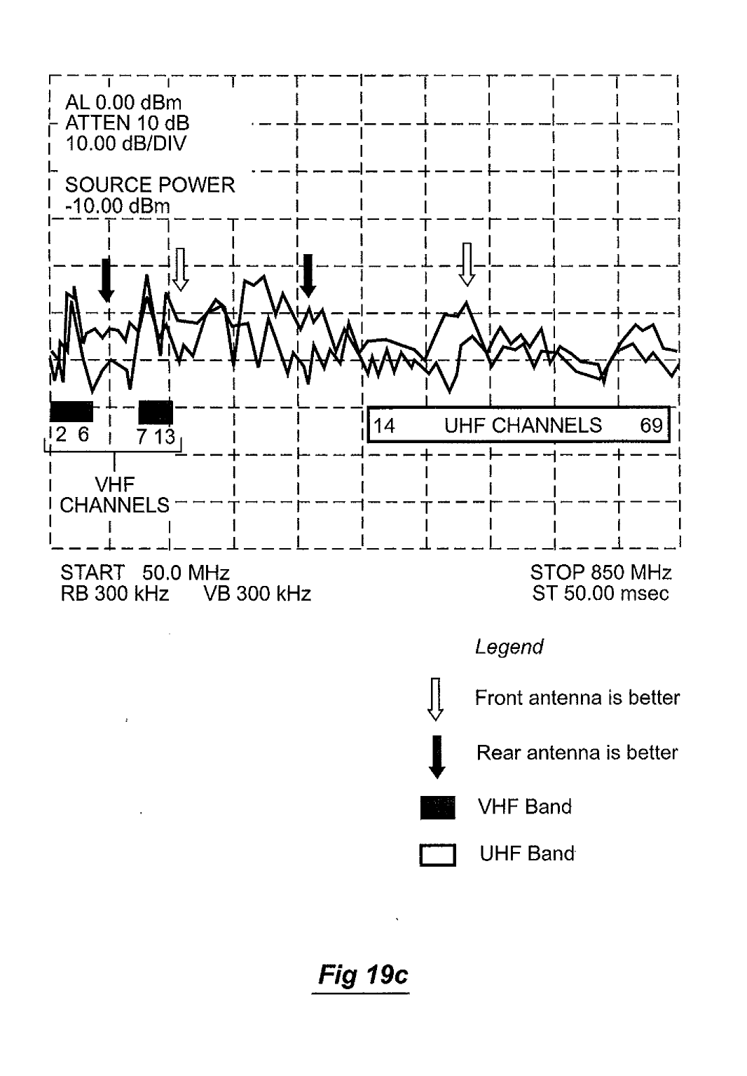

FIGS. 19a and 19b show the frequency plots of the front (FIG. 19a) and rear (FIG. 19b) antennas, 100 and 1000, as described above. FIG. 19c shows the combined performance with respect to the VHF and UHF channels as well as the frequencies wherein the front antenna 100 has better performance than the rear antenna 1000 and vice-versa. FIG. 19c shows the interpolated two plots for the front and rear antennas 100, 1000. The plots are made in a 5m antenna range for the TV VHF and UHF bands relative to each other. The Y axis shows the frequency sweep from 50 MHz to 850 MHz with 80 MHz/div and the Y axis shows the received power in dBm at 10 dB/div. The sweep is made with −10 dBm transmit power, the analyzer Reference Level (RL) is set to 0 dBm, Resolution (RB) and Video Bandwidth (VB) to 300 kHz. The VHF TV bands are shown with the related channels and the UHF is also shown. The dominant front antenna 100 behavior and the dominant rear antenna 1000 behavior are also shown. Both antennas 100 and 1000 compensate adjacent frequency areas so as complement to each other and the combined performance will improve the overall reception. The front antenna pattern may be enough for supporting the main TV bandwidth as the improvements from the rear antenna falls mainly in areas with no active TV channels, although there is a benefit of using the rear antenna to improve the low VHF channel reception. The method of using two antennas may be implemented either by combining them when matching the received signal phase or switching them on diversity basis.

The above described antennas may be embodied in other specific forms, shapes and architectures based on the teachings herein. Further, certain precise dimension values have been utilized in the specification. However, these dimensions, either precisely stated or stated with the word “about”, do not limit the scope of the claimed invention and that variations in lengths, spacings, environmental openings, shapes, and configurations can occur.

It is noted that the terms “preferable” and “preferably,” are given their common definitions and are not utilized herein to limit the scope of the claimed disclosure. Rather, these terms are intended to highlight alternative or additional features that may or may not be utilized in a particular embodiment of the present disclosure.

For the purposes of describing and defining the present disclosure it is noted that the term “substantially” is given its common definition and it utilized herein to represent the inherent degree of uncertainty that may be attributed to any shape or other representation.

Those skilled in this art will appreciate that various changes, modifications, use of other materials, other structural arrangements, and other embodiments could be practiced under the teachings of the invention without departing from the scope of this invention as set forth in the following claims.

I claim:

1. An internal television dual band antenna for a portable entertainment module having a screen, said portable entertainment module having a bezel around said screen, said internal television dual band antenna comprising:
a first antenna element in said bezel for receiving very high frequency broadcast television signals, said first antenna element having a first length extending in said bezel around said screen from a first signal output;
a second antenna element in said bezel for receiving ultra high frequency broadcast television signals, said second antenna element spaced from and parallel to said first antenna element, said second antenna element extending in said bezel around said screen a second length from a second signal output in the same direction as said first antenna element, said first length being longer than said second length;
said first and second signal outputs located near the same position on said bezel, said first and second outputs located inside said portable entertainment module.

2. The internal television dual band antenna of claim 1 wherein said first and second antenna elements are each formed of conductive wire embedded in a groove formed in said bezel.

3. The internal television dual band antenna of claim 2 wherein the outer periphery of said screen affixes to said bezel over said formed grooves.

4. The internal television dual band antenna of claim 1 wherein said first length of said first antenna element compensates for reception influences caused by said portable entertainment module to receive television broadcast signals in said very high frequency range.

5. The internal television dual band antenna of claim 4 wherein said screen has four sides and wherein said first antenna has said first length extending in said four sides.

6. The internal television dual band antenna of claim 1 wherein said second length of said second antenna element compensates for reception influences caused by said portable entertainment module to receive television broadcast signals in said ultra high frequency range.

7. The internal television dual band antenna of claim 6 wherein said screen has four sides and wherein said second antenna has said second length extending in three of said four sides.

8. The internal television dual band antenna of claim 1 further comprising:
a rear antenna located inside said portable entertainment module behind said screen for receiving both said very high frequency and ultra high frequency broadcast television signals, said rear antenna having rear signal outputs operatively connected with said first and second signal outputs.

9. The internal dual band antenna of claim 8 wherein said operatively connected comprises:
a first impedance matching circuit connected to said first and second signal outputs for generating a first television output signal;
a second impedance matching circuit connected to said rear signal output for generating a second television output signal;
a combine circuit connected to said first and second television output signals for outputting a combined television output signal.

10. The internal dual band antenna of claim 8 wherein said operatively connected comprises:
a first impedance matching circuit connected to said first and second signal outputs for generating a first television output signal;
a second impedance matching circuit connected to said rear signal output for generating a second television output signal;
a switch circuit connected to said first and second television output signals for selecting one of said television output signals as a selected television output signal.

11. The internal television dual band antenna of claim 8 wherein said portable entertainment module includes a housing, air vents, and internal components, said rear antenna further comprising:
a substrate sized to fit inside said housing, said substrate having formed environmental openings over said air vents and over said internal components;
a logo-periodic planar antenna printed on said substrate;
said substrate with said printed antenna affixed inside said housing with said formed environmental openings over said vents and said internal components.

12. The internal television dual band antenna of claim 11 wherein said rear antenna is modified to fit around said formed environmental openings.

13. An internal television dual band antenna for a portable entertainment module having a screen, said portable entertainment module having a bezel around said screen, said television dual band antenna comprising:
a first antenna element in said portable entertainment module, said first antenna element having a first length tuned to receive very high frequency broadcast television signals, said first antenna element extending in said portable entertainment module around said screen said first length from a first signal output, said first length of said first antenna element compensating for reception influences caused by said portable entertainment module to receive said television broadcast signals in said very high frequency range;
a second antenna element in said portable entertainment module, said second antenna element having a second length tuned to receive ultra high frequency broadcast television signals, said second antenna element spaced from and parallel to said first antenna element, said second antenna element extending in said portable entertainment module around said screen a second length from a second signal output in the same direction as said first antenna element, said second length of said second antenna element compensating for reception influences caused by said portable entertainment module to receive said television broadcast signals in said ultra high frequency range;
each of said first and second antenna elements formed of conductive wire embedded in a groove formed in said bezel.

14. The internal television dual band antenna of claim 13 wherein the outer periphery of said screen affixes to said bezel over said formed grooves.

15. The internal television dual band antenna of claim 13 wherein said screen has four sides, wherein said first antenna has said first length extending in said four sides and wherein said second antenna has said second length extending in three of said four sides.

16. The internal television dual band antenna of claim 13 wherein said first and second signal outputs are located near the same position inside said portable entertainment module.

17. The internal television dual band antenna of claim 13 further comprising:
a rear antenna located inside said portable entertainment module behind said screen for receiving both said very high frequency and ultra high frequency broadcast television signals, said rear antenna having rear signal outputs connected to said first and second signal outputs.

18. The internal television dual band antenna of claim 17 wherein said portable entertainment module includes a housing, air vents, and internal components, said rear antenna further comprising:
a substrate sized to fit inside said housing, said substrate having formed environmental openings over said air vents and over said internal components;
a logo-periodic planar antenna printed on said substrate;
said substrate with said printed antenna affixed inside said housing with said formed environmental openings over said vents and said internal components.

19. A pair of internal television antennas for a portable entertainment module having a housing, a display screen and a bezel around said display screen, said pair of antennas comprising:
a front antenna having first signal outputs, said front antenna embedded in said bezel around said display screen, said front antenna compensating for reception influences caused by said portable entertainment module to receive said television broadcast signals;
a rear antenna having second signal outputs, said rear antenna located inside and at the rear of said housing, said rear antenna having elements modified in shape to form environmental openings around internal components in the housing;
said front and said rear antennas having different architectural antenna shapes, said first and second signal outputs interconnected together.

20. A method of receiving television broadcast signals in a portable entertainment module having a housing and a display screen, said method comprising:
receiving the television broadcast signals in a first antenna element, embedded in the housing around the display screen, having a length tuned (1) to receive very high frequency broadcast television signals and (2) to compensate for reception influences caused by said portable entertainment module;
receiving the television broadcast signals in a second antenna element, embedded in the housing around the display screen and parallel to the first antenna element, having a length tuned (1) to receive ultra high frequency broadcast television signals and (2) to compensate for reception influences caused by said portable entertainment module;
combining signal outputs from the first and second antenna elements.

21. The method of claim 18, further comprising:
receiving the television broadcast signals in a rear antenna located inside the rear of the housing, said rear antenna having elements modified in shape to form environmental openings around internal components in the housing;
combining the received television broadcast signal output from the first and second antenna elements with the received television broadcast signal output from the third antenna.
